(19) United States
(12) Patent Application Publication
(10) Pub. No.: US 2025/0080807 A1
(43) Pub. Date: Mar. 6, 2025

(54) METHODS AND SYSTEMS FOR DISPLAYING CAPTIONS FOR MEDIA CONTENT

(71) Applicant: Adeia Guides Inc., San Jose, CA (US)

(72) Inventors: Ning Xu, Irvine, CA (US); Tao Chen, Palo Alto, CA (US); Serhad Doken, Bryn Mawr, PA (US)

(21) Appl. No.: 18/240,581

(22) Filed: Aug. 31, 2023

(51) Int. Cl. H04N 21/488; G06T 5/00; H04N 21/233; H04N 21/258; H04N 21/485

(52) U.S. Cl. CPC H04N 21/4884; G06T 5/77; H04N 21/233; H04N 21/25891; H04N 21/4856

(57) ABSTRACT

System and methods are provided to analyze media content to determine one or more parameters associated with the media content. Metadata is generated storing the one or more parameters. A request to display the media content with second captions is received. Second captions are generated for display based on the metadata.

### BACKGROUND

The present disclosure relates to methods and systems for displaying captions for media content. Particularly, but not exclusively, the present disclosure relates to methods and systems for generating metadata for media content having burned-in captions, and generating alternative captions for the media content based on the metadata.

### SUMMARY

It is common for media content to be provided with burned-in (i.e., open captions) with the aim of making the media content accessible to a wider audience. However, in some cases, the burned-in captions may not be appropriate for a use case. For example, the burned-in captions may be in a language different from a language desired by a user. Should alternative captions be desired, it may result in captioning that overlays the burned-in captions, creating a confusing and distracting viewing experience.

Systems and methods are provided herein for improving the display of alternative captions for media content, e.g., by generating alternative closed-captioning to replace or obscure burned-in captions. For example, the systems and methods disclosed herein may provide an automatic removal and/or replacement of burned-in captions, e.g., based on one or more user preferences for captioning of media content.

In some examples, the systems and methods analyze media content, e.g., before it is encoded for transmission, to determine information relating to the media content. The information may comprise one or more parameters of the media content, such as the presence, location, appearance, quality and/or language of burned-in captions, and the language of the audio of the media content. This information is stored as metadata for later access. A captioning function for the media content may be controlled (e.g., by a user) or managed (e.g., by a content provider), based on the metadata, to present enhanced captions to a user, e.g., by preventing the display of conflicting captions or undesired captions, or even a higher quality version of the captions.

According to one aspect of the present disclosure, systems and methods are configured to analyze media content to determine one or more parameters associated with first captions, e.g., open/burned-in captions, of the media content. Metadata is generated storing the one or more parameters, e.g., prior to display of the media content. A request to display the media content with second captions is received. Second captions are generated for display based on the metadata. For example, metadata describing one or more parameters of the first captions can be used to generate second captions in an optimal and enhanced manner, e.g., to suit one or more preferences of an audience of the media content and/or to comply with one or more system settings.

In some examples, a user preference and/or a system setting may relate to a language, a size, a font, a color, a quality, a location, a display mode (scroll versus page-through), etc. of the first captions. In some examples, a preference and/or a system setting may relate to displaying, e.g., selectively displaying, closed captions or subtitles. The second captions may be generated in response to the first captions not meeting one or more user preferences and/or system settings. In some examples, based on the metadata, it is determined whether the first captions do not meet one or more user preferences and/or system settings.

In some examples, a request to display the second captions in a language (e.g., a second language or a requested language) is received. The metadata may be accessed, e.g., automatically, in response to the request. Based on the metadata, it is determined whether the language of the requested second captions matches a language of the first captions. In response to the requested language matching the language, of the first captions, the request to display the second captions may be disregarded. In some examples, an instruction to generate second captions may be overridden in response to the first language matching the second language. In some examples, user may be notified of this action via an audio-visual notification.

In some examples, analyzing the media content comprises determining one or more portions of the media content having the first captions, e.g., using machine learning and/or image processing techniques. In some examples, analyzing the media content comprises determining a visual parameter of the first captions, e.g., an area/location/font/size of the first captions, e.g., using machine learning and/or image processing techniques. In some examples, analyzing the media content comprises determining an audio parameter of the media content, e.g., using speech recognition and/or natural language processing (NLP) techniques to analyze the audio and identify its language and/or quality of the audio. In some examples, analyzing the media content comprises accessing metadata of the media content, e.g., to determine a language/audio track of the media content. Analyzing the media content may be performed in real time or near-real time.

In some examples, modified media content is generated by removing the first captions, e.g., using an in-painting algorithm. A stream for transmitting the media content may be generated, the stream having a version of the modified media content and a version of unmodified media content encoded therein, which results in different versions of the media content being transmitted in the stream. A user preference may be determined, e.g., by accessing a user profile and/or system settings. The user preference may be compared with the metadata. In some examples, the unmodified media content is decoded for display when the user preference matches a parameter stored in the metadata, e.g., when a language of the captions matches a user language preference. In some examples, the modified media content is decoded for display when the user preference does not match a parameter stored in the metadata, e.g., when a language of the captions does not match a user language preference.

In some examples, the media content is processed to generate modified media content not having the first captions. In some examples, the media content is processed to generate a file containing first caption data. For example, the media content may be processed to generate a clean version (i.e., without burned-in captions) and a file having the first caption data. The first caption data may comprise data and/or instructions for generating and displaying the first captions on a version of the media content. In some examples, a stream is generated for transmitting the media content, the stream having a version the modified media content and the first caption data encoded therein. A user preference may be determined and compared with the metadata. In some examples, the modified media content is decoded for display when the user preference does not match a parameter stored in the metadata, e.g., when the first captions are presented in a non-preferred style and/or language. In some examples, the modified media content and the first caption data are decoded for display when the user preference matches a parameter stored in the metadata. For example, the first caption data may be decoded and added into the modified version of the media content, thereby arriving at a third version of the media content that is representative of the unmodified version.

In some examples, a requested volume level of the media content is determined. For example, control circuitry may access a volume setting of a user device to determine a current volume level. A requested volume level may be determined by receiving an input, e.g., from a controller of the user device, to change the current volume level to a new level, e.g., the requested level. In some examples, the unmodified version of the media content is displayed by default when the requested volume level is below a predetermined volume level, e.g., volume threshold (e.g., 10%, 20%, 50%, or any other desired percent of a max volume).

In some examples, a quality, e.g., an accuracy in translation and/or transcription, a reading level, a visual quality, e.g., resolution, etc., of the first captions is determined. The quality may be compared with a quality value. In some examples, when the quality is less than the quality value, e.g., a threshold quality, a request to display the media content with second caption may be generated and/or received. In this manner, low quality, e.g., inaccurate, first captions may be replaced automatically by the second captions.

In some examples, the second captions may be displayed at a position on the media content to not obscure the first captions, e.g., to avoid second captions preventing first captions from being read. In some examples, the second captions may be displayed at a position on the media content to obscure the first captions, e.g., to avoid double captioning.

According to one aspect of the present disclosure, systems and methods are configured to receive media content having first captions. The media content is processed to generate modified media content not having first captions. In some examples, the media content is processed to generate a file containing first caption data. The first caption data may comprise data and/or instructions for generating and displaying the first captions on a version of the media content. A stream is generated for transmitting the media content, the stream having at least one of a version of the modified media content, a version of the unmodified media content and/or the first caption data encoded therein. A user preference is determined and compared with the metadata.

In some examples, the unmodified media content is decoded for display when the user preference matches a parameter stored in the metadata, e.g., when a language of the captions match a user language preference. In some examples, the modified media content is decoded for display when the user preference does not match a parameter stored in the metadata, e.g., when a language of the captions does not match a user language preference.

In some examples, the modified media content is decoded for display when the user preference does not match a parameter stored in the metadata, e.g., when the first captions are presented in a non-preferred style and/or language. In some examples, the modified media content and the first caption data are decoded for display when the user preference matches a parameter stored in the metadata.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 illustrates an overview of the system for displaying captions, in accordance with some examples of the disclosure;

FIG. 2 is a block diagram showing components of an example system for displaying captions, in accordance with some examples of the disclosure;

FIG. 3 is a flowchart representing a process for displaying captions, in accordance with some examples of the disclosure;

FIG. 4 is a table showing metadata associated with captions;

FIG. 5 is a flowchart representing a process for displaying second captions based on metadata for first captions, in accordance with some examples of the disclosure;

FIG. 6 is a flowchart representing a process for displaying media content with or without first captions, in accordance with some examples of the disclosure; and

FIG. 7 is a flowchart representing a process for displaying media content with or without first captions, in accordance with some examples of the disclosure.

### DETAILED DESCRIPTION

Captioning and subtitling are both processes of displaying text on a television, video screen, or other visual display to provide additional or interpretive information. Both captions and subtitles are conventionally shown as a transcription of the speech in an audio portion of a media asset (e.g., a video) as it occurs. Captions are a transcription or translation of the dialogue, sound effects, relevant musical cues, and other relevant audio information when sound is unavailable or not clearly audible, whereas subtitles may be thought of as a transcription or translation of the dialogue when sound is available but not understood.

Captions and subtitles may also be referred to colloquially as timed text. Timed text refers to the presentation of text media in synchrony with other media assets, such as audio and video. For the avoidance of doubt, this below description uses to the term “captions” generally and the scope of the disclosure is not limited to such. For example, where technically feasible, the present disclosure applies equally to captions and/or subtitles, or timed text more broadly.

Captions may be associated with “media content.” That is, media content may include, reference, or otherwise be associated with captions that may be provided (e.g., in a synchronized fashion) when the media content is played or provided. As used herein, “media content” refers to media or multimedia information that may be transmitted, received, stored, or output (e.g., displayed) in a manner consistent with the described techniques. When provided by way of an output device (e.g., a display, speaker, or haptic motor), media content may include consumable or observable audible, visual, or tactile aspects. Media content may be or include media such as text (e.g., raw text or hyperlinks), audio (e.g., speech or music), image(s), video(s), scene data or models for rendering 3D scenes, 3D renderings (e.g., rendered from scene data), or haptic information for generating haptic feedback. Media content may be or include interactive media that enables a user to control or manipulate the way the interactive media is presented (e.g., video games). Media content may be embodied in one or more content items (e.g., a set of files or data referenceable to play a movie). In some circumstances, a content item may be considered divisible. For example, a movie or video clip may be considered a content item. The movie or video clip may include multiple discreet segments or portions, each of which may be considered a content item. In some instances, a content item may be divided into multiple smaller or shorter content items to facilitate the output of other content items (e.g., advertising content) between output of the smaller content items. As another example, a video may include multiple images, each of which may be considered a content item. Media content may be delivered for real-time output (e.g., live streamed), or for storage and subsequent retrieval and output. Example media content includes movies; shows; recordings, streams, or broadcasts of events (e.g., sporting events, concerts, etc.); video clips (e.g., available via social media); video games (e.g., including cut scenes); advertisements or commercials; or extended reality content.

Captions for media content can be either open or closed. Closed captions can be turned on or off, e.g., in response to a user input or instruction. Open captions are different from closed captions in that they are part of the video itself and cannot be turned on or off. Systems and methods are provided herein for displaying captions, e.g., alternative captions (closed captions), for media content based on parameters associated with burned-in captions (open captions) of the media content.

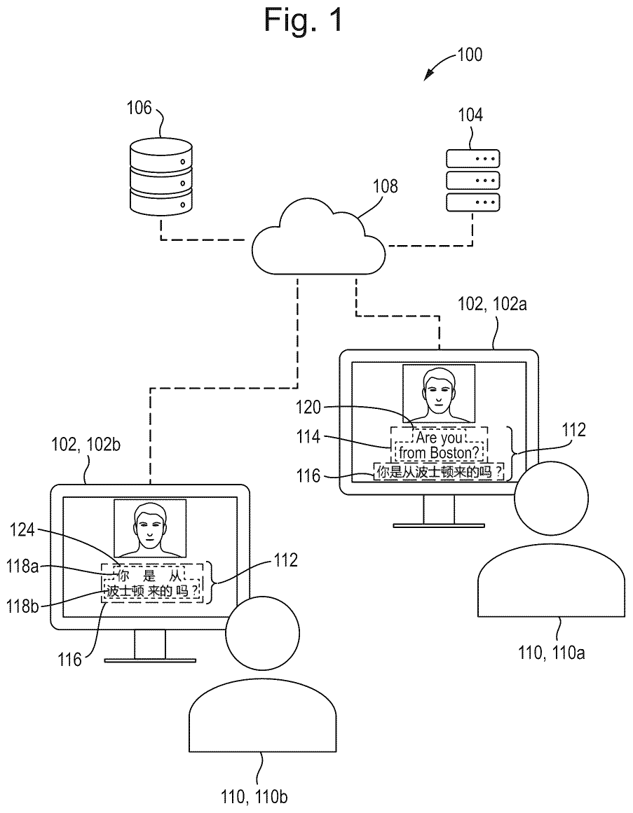

FIG. 1 illustrates an overview of a system 100 for displaying captions. The example shown in FIG. 1 illustrates users 110 interacting with respective user devices 102. For example, user device 102 may be any appropriate type of user device 102 configured to display media content for consumption by a user 110. In the example shown in FIG. 1, user device 102 is communicatively coupled to a server 104 and a database 106, e.g., via network 108. In this manner, user device 102 provides user 110 with access to (cloud) services, e.g., provided by an operator of server 104, which can retrieve data from one or more databases for responding to a user's input.

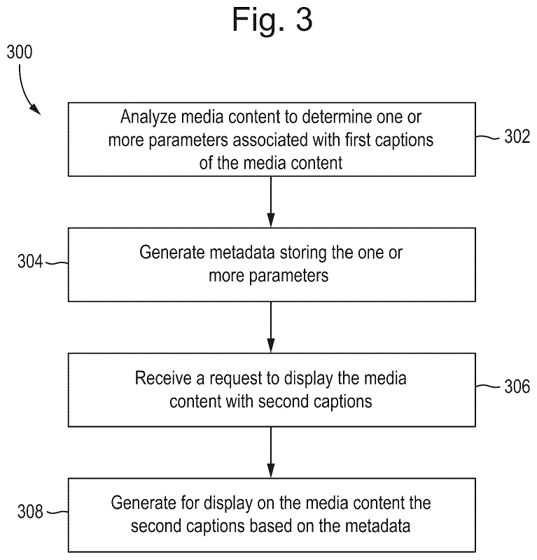

FIG. 1 shows an example of users 110 viewing media content having captions 112. More specifically, user device 102a displays media content having first captions 114, e.g., open captions and second captions 116, e.g., closed captions, positioned adjacent each other, while user device 102b displays media content having second captions 116, e.g., closed captions positioned to obscure first captions 114, e.g., open captions which are no longer visible. For example, second captions 116 may be generated based on one or more parameters of the first captions 114 including, but not limited to, language, timing, display location, content (e.g., words and/or phrases of the first captions), display style (e.g., font, text size, etc.). As shown in FIG. 1, the systems and methods disclosed herein provide improved techniques for generating and selectively displaying second captions 116 based on one or more parameters associated with first captions 114 of the media content, e.g., to position the second captions 116 to not overlay (or otherwise impede viewing of) the first captions 114, or to position the second captions 116 to overlay the first captions 114, such that the first captions 114 do not interfere with the viewing of the second captions. The examples shown in FIG. 1 are described in more detail below, with reference to the processes shown in FIGS. 3 and 5-7.

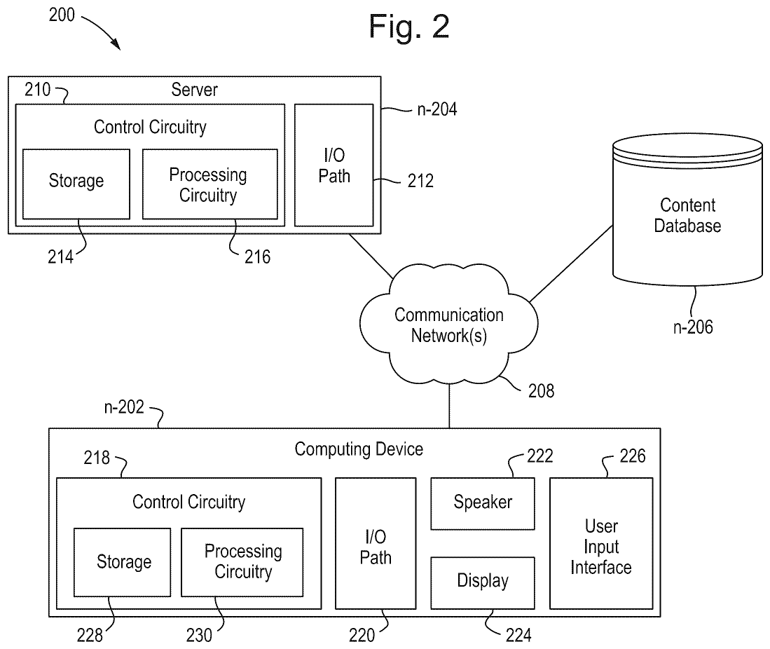

FIG. 2 is an illustrative block diagram showing example system 200, e.g., a non-transitory computer-readable medium, configured to generate for display on media content second captions based on metadata derived from one or more parameters associated with first captions of the media content. Although FIG. 2 shows system 200 as including a number of components and a configuration of individual components, in some examples, any number of the components of system 200 may be combined and/or integrated as one device, e.g., as user device 102. System 200 includes computing device n-202 (denoting any appropriate number of computing devices, such as user device 102), server n-204 (denoting any appropriate number of servers, such as server 104), and one or more content databases n-206 (denoting any appropriate number of content databases, such as content database 106), each of which is communicatively coupled to communication network 208, which may be the Internet or any other suitable network or group of networks, such as network 108. In some examples, system 200 excludes server n-204, and functionality that would otherwise be implemented by server n-204 is instead implemented by other components of system 200, such as computing device n-202. For example, computing device n-202 may implement some or all of the functionality of server n-204, allowing computing device n-202 to communicate directly with content database n-206. In still other examples, server n-204 works in conjunction with computing device n-202 to implement certain functionality described herein in a distributed or cooperative manner.

Server n-204 includes control circuitry 210 and input/output (hereinafter “I/O”) path 212, and control circuitry 210 includes storage 214 and processing circuitry 216. Computing device n-202, which may be an HMD, a personal computer, a laptop computer, a tablet computer, a smartphone, a smart television, or any other type of computing device for displaying media content, includes control circuitry 218, I/O path 220, speaker 222, display 224, and user input interface 226. Control circuitry 218 includes storage 228 and processing circuitry 220. Control circuitry 210 and/or 218 may be based on any suitable processing circuitry such as processing circuitry 216 and/or 230. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some examples, processing circuitry may be distributed across multiple separate processors, for example, multiple of the same type of processors (e.g., two Intel Core i9 processors) or multiple different processors (e.g., an Intel Core i7 processor and an Intel Core i9 processor).

Each of storage 214, 228 and/or storages of other components of system 200 (e.g., storages of content database n-206, and/or the like) may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 214, 228, and/or storages of other components of system 200 may be used to store various types of content, metadata, and or other types of data. Non-volatile memory may also be used (e.g., to launch a boot-up routine and other instructions). Cloud-based storage may be used to supplement storages 214, 228 or instead of storages 214, 228. In some examples, control circuitry 210 and/or 218 executes instructions for an application stored in memory (e.g., storage 214 and/or 228). Specifically, control circuitry 210 and/or 218 may be instructed by the application to perform the functions discussed herein. In some implementations, any action performed by control circuitry 210 and/or 218 may be based on instructions received from the application. For example, the application may be implemented as software or a set of executable instructions that may be stored in storage 214 and/or 228 and executed by control circuitry 210 and/or 218. In some examples, the application may be a client/server application where only a client application resides on computing device n-202, and a server application resides on server n-204.

The application may be implemented using any suitable architecture. For example, it may be a stand-alone application wholly implemented on computing device n-202. In such an approach, instructions for the application are stored locally (e.g., in storage 228), and data for use by the application is downloaded on a periodic basis (e.g., from an out-of-band feed, from an Internet resource, or using another suitable approach). Control circuitry 218 may retrieve instructions for the application from storage 228 and process the instructions to perform the functionality described herein. Based on the processed instructions, control circuitry 218 may determine what action to perform when input is received from user input interface 226.

In client/server-based examples, control circuitry 218 may include communication circuitry suitable for communicating with an application server (e.g., server n-204) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 208). In another example of a client/server-based application, control circuitry 218 runs a web browser that interprets web pages provided by a remote server (e.g., server n-204). For example, the remote server may store the instructions for the application in a storage device. The remote server may process the stored instructions using circuitry (e.g., control circuitry 210) and/or generate displays. Computing device n-202 may receive the displays generated by the remote server and may display the content of the displays locally via display 224. This way, the processing of the instructions is performed remotely (e.g., by server n-204) while the resulting displays, such as the display windows described elsewhere herein, are provided locally on computing device n-202. Computing device n-202 may receive inputs from the user via input interface 226 and transmit those inputs to the remote server for processing and generating the corresponding displays.

Computing device n-202 may send instructions, e.g., to generate captions, to control circuitry 210 and/or 218 using user input interface 226. User input interface 226 may be any suitable user interface, such as a remote control, trackball, keypad, keyboard, touchscreen, touchpad, stylus input, joystick, voice recognition interface, gaming controller, or other user input interfaces. User input interface 226 may be integrated with or combined with display 224, which may be a monitor, a television, a liquid crystal display (LCD), an electronic ink display, or any other equipment suitable for displaying visual images.

Server n-204 and computing device n-202 may transmit and receive content and data via I/O path 212 and 220, respectively. For instance, I/O path 212, and/or I/O path 220 may include a communication port(s) configured to transmit and/or receive (for instance to and/or from content database n-206), via communication network 208, content item identifiers, content metadata, natural language queries, and/or other data. Control circuitry 210 and/or 218 may be used to send and receive commands, requests, and other suitable data using I/O paths 212 and/or 220.

FIG. 3 shows a flowchart representing an illustrative process 300 for generating captions. While the example shown in FIG. 3 refers to the use of system 100, as shown in FIG. 1, it will be appreciated that the illustrative process 300 shown in FIG. 3 may be implemented, in whole or in part, on system 100, system 200, and/or any other appropriately configured system architecture. For the avoidance of doubt, the term “control circuitry” used in the below description applies broadly to the control circuitry, e.g., as outlined above with reference to FIG. 2. For example, control circuitry may comprise control circuitry of user device 102 and control circuitry of server 104, working either alone or in some combination.

At 302, control circuitry, e.g., control circuitry of server 104, analyzes media content to determine one or more parameters associated with first captions 114 (e.g., burned-in captions) of the media content. For example, the media content may be analyzed using machine learning, audio recognition, image recognition and/or any other appropriate techniques to analyze the media content, e.g., to detect the presence of first captions 114 in one or more frames of the media content. For example, upon detection of first captions 114, e.g., between a temporal starting frame and a temporal ending frame, control circuitry may be configured to determine a location of the first captions 114 within a frame, e.g., between the temporal starting frame and the temporal ending frame of the media content. The location of the first captions 114 may be defined as a coordinate of a centroid of a bounding box around the first captions 114, and/or by determining coordinates representing corners of a bounding box surrounding the first captions 114. In some examples, a size of the first captions 114 may be determined. For example, control circuitry may determine an area of a bounding box surrounding the first captions 114, and express the area covered by the first captions 114 as a percentage of the total area of the frame. In some examples, control circuitry may determine a shape of the first captions 114, e.g., a shape formed by a bounding box surrounding the first captions 114. In some examples, the shape may be a rectangle or a compound rectangle. However, the shape may be any appropriate shape, e.g., a shape based at least in part on one or more visual elements of the frame in which the first captions 114 appear. Additionally or alternatively, control circuitry may be configured to determine a language of the first captions 114, e.g., using natural language processing techniques, such as optical character recognition. In some examples, an appearance of the first captions 114 may be determined, e.g., a color, a size and/or a font. Additionally or alternatively, control circuitry may analyse the first captions 114 to determine the content of the first captions 114, e.g., using natural language processing techniques, such as speech recognition. In some examples, control circuitry may apply natural language processing techniques to analyze an audio track associated with the frame and identify its language. The determined parameters associated with first captions 114 are then stored as metadata. It is beneficial to perform the analysis at 302 even though metadata relating to burned-in captions may be provided by a content provider and/or through manual input, since it is not mandatory practice to include such metadata in media content encoding production. In some cases, such metadata may not be entirely copied when transcoding media content, e.g., across various platforms. Thus, in the context of generating alternative captions, e.g., second captions 116, it is more reliable to analyse the media content, e.g., at server 104, to ensure that accurate metadata is associated with the media content. Such metadata can then be populated to various encoded versions of the media content in an adaptive bit rate ladder, so that each stream can use the metadata.

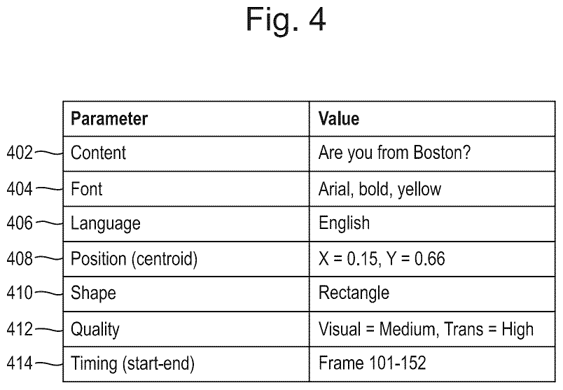

At 304, control circuitry, e.g., control circuitry of server 104, generates metadata storing the one or more parameters determined at 302. FIG. 4 shows a table 400 representing the stored metadata, which describes the first captions 114. In the example shown in FIG. 1, the first captions 114 read “Are you from Boston?”, which is stored in the “Content” field 402. The appearance of the first captions 114 is stored in the “Font” field 404, e.g., “Arial, bold yellow”. The language of the first captions 114 is stored in the “Language” field 406, e.g., “English”. The position of the first captions 114 is stored in the “Position” field 408, e.g., “X=0.15, Y=0.66”, which may be the coordinates of a centroid of a bounding box around the first captions 114. However, the position of the first captions 114 may be defined in any appropriate manner, such as by the relative positions of the center or an edge of a frame and the centroid and/or an edge of a bounding box around the first captions 114. The shape of the first captions 114 is stored in the “Shape” field 410, e.g., “Rectangle”, or another appropriate shape. The quality of the first captions 114 is stored in the “Quality” field 412, e.g., “Visual=Medium, Trans=High”. In some examples, a visual quality of the first captions 114 may be based on various factors, such as anti-aliasing, video/projection quality and display pixel density. However, the visual quality may be represented by a score, such as “medium”, accounting for various quality factors. Additionally or alternatively, the “Quality” field 412 may store information relating to the quality of the translation and/or transcription of the first captions 114. For example, control circuitry may be configured to compare results of the natural language processing of the first captions 114 and the audio track of the media content, e.g., to determine whether the first captions 114 accurately transcribe and/or translate the speech of the media content. In some examples, the audio quality may be represented by a score, e.g., “high”, accounting for a good match between the results of the natural language processing of the first captions 114 and the audio track of the media content. For example, a “high” score may be given when the number of errors in the transcription of the audio track is less than a predetermined number of errors (e.g., an error threshold). The timing of the first captions 114 is stored in the “Timing” field 414, e.g., “Frame 101-152”, which indicates that the first captions 114 are first displayed at frame 101 and cease to be displayed after frame 152. It will be appreciated that the disclosure is not limited to the types of parameters shown in FIG. 4. Indeed, the disclosure extends to any appropriate parameter that can be used to describe the first captions 114 and the media content, and the parameters shown in FIG. 4 are merely by way of example.

At 306, control circuitry, e.g., control circuitry of user device 102 and/or server 104, receives a request to display the media content with second captions. In the example shown in FIG. 1, user 110a issues an instruction to user device 102 to display second captions 116 in a language different from the language of the first captions 114, e.g., Chinese. For example, user 110a may navigate one or more menus to select Chinese closed captions or issue a voice command to user device 102, requesting the display of Chinese closed captions. In some examples, control circuitry of user device 102 may access a user profile of user 110a to determine at least one caption preference, such as a preferred language, font, position, etc. Upon determination of a caption preference, user device 102 may request, from server 104, the display of captions in the preferred language, font and position. In other words, control circuitry may be configured to automatically provide the display of second captions 116 for the media content, e.g., upon determination of one or more user preferences.

At 308, control circuitry, e.g., control circuitry of user device 102 and/or server 104, generates for display on the media content second captions 116 based on the metadata determined at 304. In some examples, when user 110 requests to play media content, control circuitry may activate a caption control function to control how captions are displayed on user device 102. For example, control circuitry may access the metadata to determine a position of the first captions 114 and position the second captions 116 relative to the first captions 114, e.g., to ensure that the second captions 116 do not overly, e.g., at least partially obscure, the first captions 114. In some examples, as shown in FIG. 1, user 110a has a preference for the second captions 116 to be positioned underneath the first captions 114, e.g., to maintain visibility of first captions 114 and the second captions 116 at the same time. For example, control circuitry may be configured to align, e.g., vertically, a centroid of a bounding box around the first captions 114 and a centroid of a bounding box around the second captions 116, and a bottom edge of the bounding box around the first captions 114 and a top edge of the bounding box around the second captions 116. However, any appropriate position of the second captions 116 relative to the first captions 114 may be implemented. For example, control circuitry may be configured to determine, e.g., automatically determine, any appropriate position for the display of the second captions 116, e.g., in response to a user preference not able to be satisfied and/or a contractual obligation of between a service/content provider not permitting the display of second captions 116 (such obligations may also be stored in the metadata).

In some alternative examples, in response to receiving a request to play media content with closed captions (e.g., second captions 116), control circuitry may access the stored metadata for a segment of the media content currently being displayed, and compare a selected closed caption language with the language of the first captions 114. Should the selected closed caption language match the language of the first captions 114, control circuitry may deactivate, e.g., automatically deactivate, the closed captioning function, e.g., for the selected language. In response to deactivating the function, control circuitry may provide a notification to user 110 indicating that the closed captioning function has been deactivated and open captions (e.g., first captions 114) are being displayed. In such a case, the second captions 116 are not generated for display at 308. Such a process may improve operational efficiency, by avoiding generating the second captions 116 for display, which are not needed as they duplicate the first captions 114.

The actions or descriptions of FIG. 3 may be done in any suitable alternative orders or in parallel to further the purposes of this disclosure, and may be combined, where technically appropriate, with the actions or descriptions of any other of the FIGS. disclosed herein.

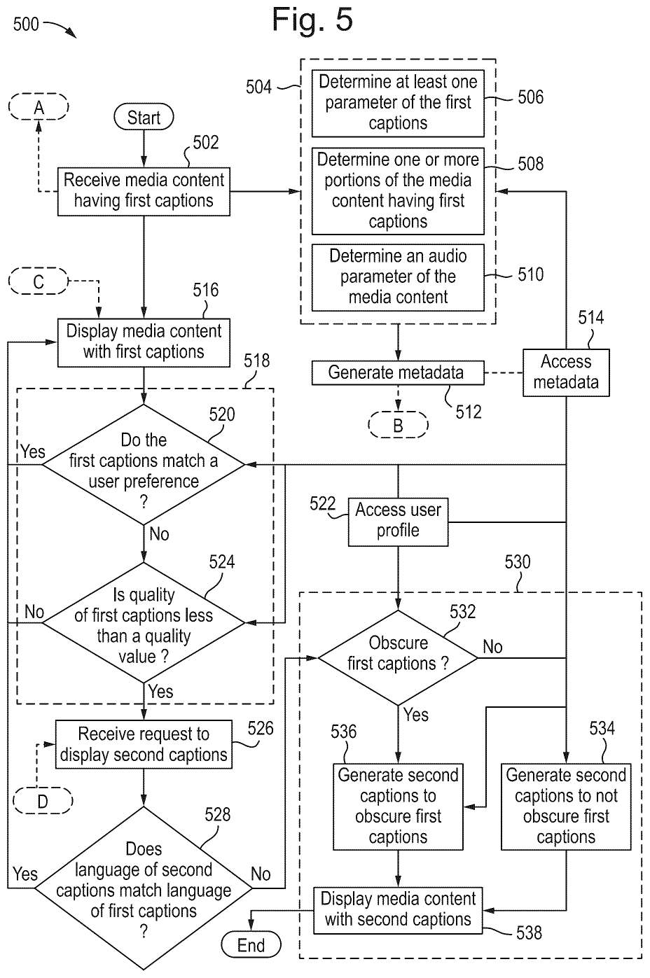

FIG. 5 shows a flowchart representing an illustrative process 500 for displaying media content with second captions. While the example shown in FIG. 5 refers to the use of system 100, as shown in FIG. 1, it will be appreciated that the illustrative process 500 shown in FIG. 5 may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of user device 102 and control circuitry of server 104, working either alone or in some combination.

At 502, control circuitry, e.g., control circuitry of server 104, receives media content having first captions 114. For example, the media content may be provided to an operator of server 104 by one or more content providers. In some examples, 502 of process 500 may link with process 600 and/or process 700, which are described below, via arrow A.

At 504, control circuitry, e.g., control circuitry of server 104, analyzes the media content to determine one or more parameters associated with the media content, e.g., in a manner similar to that described above for 302. In the example sown in FIG. 5, 504 comprises 506, 508 and 510.

At 506, control circuitry, e.g., control circuitry of server 104, determines at least one parameter of the first captions 114. For example, control circuitry may determine values for multiple types of parameters, such as the content, font, position, shape, language, video quality, transcription quality, timing, etc., of the first captions 114, e.g., as shown in FIG. 4.

At 508, control circuitry, e.g., control circuitry of server 104, determines which portions of the media content have first captions 114. Such information may be derived from image analysis of the media content (and/or from the timing parameter derived at 506), and is useful for determining when to selectively activate a caption control function controlling the display of first captions 114 and second captions 116 on the media content.

At 510, control circuitry, e.g., control circuitry of server 104, determines an audio parameter of the media content, e.g., in a similar manner to that described above at 302. For example, control circuitry may be configured to determine a language of an audio track of the media content, e.g., a language spoken by one or more individuals in the media content. Additionally or alternatively, control circuitry may determine non-speech related audio, such as music, sound effects, etc., and timing data associated with the non-speech related audio. Such data is useful when generating second captions 116 relating to sound effects, relevant musical cues, and other relevant audio information.

At 512, control circuitry, e.g., control circuitry of server 104, generates metadata based on the steps performed at 504. For example, control circuitry may generate a table, e.g., similar to that shown in FIG. 4, for storing the parameters associated with the media content. The metadata may be stored in any appropriate place, e.g., database 106, for access at 514 during any of the proceeding steps. In some examples, the stored metadata may be accessed during step 504. For example, when analyzing the media content to determine the one or more parameters, control circuitry may access metadata to check whether information is already available for the media content. In some examples, where information is already available, control circuitry may determine to not perform one or more of 506, 508 and 510, or to still perform one or more of 506, 508 and 510 and cross reference the already available data with newly determined data in an attempt to improve the accuracy of the stored metadata, and/or incrementally increase/improve the stored metadata, e.g., when the receive media content is a different version of a previously received media content. In some examples, 512 of process 500 may link with process 600 and/or process 700, which are described below, via arrow B.

Returning to 502, in the example shown in FIG. 5, 502 moves to 516, where the received media content is displayed, e.g., in response to a user request to display the media content or an automated system request. It is to be understood that 504, 512 and 514 may occur before the media content is displayed at 516, or in parallel with the media content being displayed at 516. For example, 504, 512 and 514 may occur as a pre-analysis function, e.g., before the media content is made available for display at a user device 102. Conversely, 504, 512 and 514 may occur in real-time, or near real-time, as the media content is being displayed, e.g., where the media content is a live transmission. In the example shown in FIG. 1, users 110a and 110b are each watching media content in which an individual is speaking the phrase “Are you from Boston?”. For example, users 110a and 110b may each be watching the media content as part of a group watching session, and each user may have different preferences for the display of captions. In some examples, 516 of process 500 may link with process 600 and/or process 700, which are described below, via arrow C.

At 518, control circuitry, e.g., control circuitry of user device 102 and/or server 104, determines whether to activate a caption control function. In the example shown in FIG. 5, 518 comprises 520 and 524. While 520 and 524 are shown in series in FIG. 5, it is to be understood that in other examples, these steps may occur independently, i.e., one without the other, or in parallel. In some examples, moving from 518 to 526 defines the action of activating a caption control function. For example, 520 defines a step of determining whether to proceed with process 500 based on a user setting, while 524 defines a step of determining whether to proceed with process 500, e.g., based on a condition set by a service provider, so that low quality captions may be replaced, e.g., automatically replaced, by higher quality captions.

At 520, control circuitry, e.g., control circuitry of user device 102 and/or server 104, determines whether the first captions 114 match a user preference (and/or one or more system settings). For example, control circuitry may access the metadata at 514 and a profile of each user at 522, and then compare one or more user preference settings to the parameters stored in the metadata, e.g., as shown in FIG. 4. In the example shown in FIG. 1, user 110a has a preference to display second captions 116 in Chinese concurrently with first captions 114 in English (e.g., without the second captions 116 overlaying the first captions 114), and user 110b has a preference to display second captions 116 in Chinese, the second captions 116 obscuring the display of the first captions 114 in English. In some examples, control circuitry may determine that the first captions 114 match a user preference based on a predetermined (e.g., threshold) number of user settings matching the parameters stored in the metadata. In some examples, one or more of the parameters may be weighted or ranked lower than other parameters. For example, the font of the first captions 114 may have a lower ranking than the language of the first captions 114. At 520, when control circuitry determines that the parameters of the first captions 114 match one or more of the user preferences, process 500 moves back to 516, and display of first captions 114 is maintained. When control circuitry determines that the parameters of the first captions 114 do not match one or more of the user preferences, process 500 moves to 524. For example, in the example shown in FIG. 1, both users 110a and 110b have a preference to view captions in Chinese. Since first captions 114 are in English, process 500 moves to 524 for each user.

At 524, control circuitry, e.g., control circuitry of user device 102 and/or server 104, determines whether the quality of the first captions 114 is less than a quality value (e.g., a threshold quality level). For example, control circuitry may access the metadata at 514 to determine a visual quality of the first captions 114 and/or a translation/transcription quality of the first captions 114. Should control circuitry determine that one or both of the visual quality and the translation/transcription quality are above respective threshold values, process 500 moves back to 516, and display of first captions 114 is maintained. When control circuitry determines that one or both of the visual quality and the translation/transcription quality are below respective threshold values, process 500 moves to 526. In the example shown in FIG. 1, the series of determinations moving from 520 to 524 to 526 activates the caption control function.

At 526, control circuitry, e.g., control circuitry of server 104, receives a request to display second captions 116, e.g., in a manner similar to that described above at 306. The request may be a user generated request, e.g., enabled by a selectable option or notification generated by the caption control function, e.g., indicating that the first captions 114 do not meet the user preferences. In other cases, the request may be an automated request issued by user device 102, for example, when the first captions 114 do not meet the user's preference. In the example shown in FIG. 1, both users 110a and 110b have selected to view Chinese captions, either directly using an interface of user device 102, or indirectly by virtue of one or more user settings/preferences stored in a user profile. In some examples, 526 of process 500 may link with process 600 and/or process 700, which are described below, via arrow D.

At 528, control circuitry, e.g., control circuitry of server 104, determines whether the language of the requested captions matches the language of the first captions 114, e.g., in response to receiving the request to display second captions 116. For example, control circuitry may access the stored metadata for a segment of the media content currently being displayed, and compare the requested second caption language with the language of the first captions 114. Should the requested second caption language match the language of the first captions 114, control circuitry may deactivate, e.g., automatically deactivate, the caption control function, e.g., for the selected language. In response to deactivating the function, control circuitry may provide a notification to user 110 indicating that the caption control function has been deactivated and the first captions 114 (e.g., open captions) are being displayed. In such a case, the second captions 116 are not generated for display. Such a process may improve operational efficiency, by avoiding generating the second captions 116 for display, e.g., in a case where they duplicate or are substantially similar to the first captions 114. In the example shown in FIG. 5, when the language of the requested captions matches the language of the first captions 114, e.g., the currently displayed first captions 114, process 500 moves back to 516. When the language of the requested captions does not match the language of the first captions 114, e.g., the currently displayed first captions 114, process 500 moves to 530. In the example shown in FIG. 5, 530 comprises 532, 534, 536 and 538.

At 532, control circuitry, e.g., control circuitry of user device 102 and/or server 104, determines whether to position the second captions 116 to obscure the first captions 114. For example, control circuitry may access a user profile for each user at 522 and determine that user 110a has a preference set to not obscure the first captions 114, while user 110b has a preference set to obscure the first captions 114. In other words, user 110a wants to maintain concurrent viewing of English and Chinese captions, while user 110b wants to only see the Chinese captions. When it is determined that the first captions 114 are not to be obscured, process 500 moves to 534, and when it is determined that the first captions 114 are to be obscured, process 500 moves to 536.

At 534, control circuitry, e.g., control circuitry of user device 102 and/or server 104, generates the second captions 116 to not obscure the display of the first captions 114. For example, at 534 control circuitry accesses metadata at 514 and a user profile at 522 to generate the second captions 116 for display on the media content. In the example shown in FIG. 5, control circuitry generates the second captions 116 for display in a position underneath the first captions 114, e.g., in a manner similar to that described above at 308.

At 536, control circuitry, e.g., control circuitry of user device 102 and/or server 104, generates the second captions 116 to not obscure the display of the first captions 114. For example, at 536 control circuitry accesses metadata at 514 and a user profile at 522 to generate the second captions 116 for display on the media content. In the example shown in FIG. 5, control circuitry generates the second captions 116 for display in a position overlaying the first captions 114 (which, consequently, are not visible on user device 102b of FIG. 1). For example, control circuitry may be configured to position a centroid of a bounding box around the first captions 114 coincident with a centroid of a bounding box around the second captions 116, and align each edge of a bounding box around the first captions 114 with each edge of a bounding box around the second captions 116. However, any appropriate position of the second captions 116 relative to the first captions 114 may be implemented such that the first captions 114 are not visible when the second captions 116 are displayed. In the example shown in FIG. 1, second captions 116b are displayed in a different arrangement from the second captions 116a. in particular, control circuitry arranges the characters of second captions 116b such that the characters are sized and spaced to as to fill an area covered by the characters of the first captions 114. For example, the second captions 116b comprise a first row of characters 118a and a second row of characters 118b, each having characters evenly distributed so as the second captions 116b fill an area covered by the characters of the first captions 114. Additionally or alternatively, control circuitry may add a background fill color to obscure the first captions 114 from visibility, e.g., over an area covered by the first captions 114. In the above examples, the area covered by the first captions 114 may be determined from first captions coordinate data stored in the metadata. For example, coordinate data may define a compound rectangle 120 covering a first row and a second row of the first captions 114. In some examples, control circuitry may base the arrangement of the second captions 116 on the size and position compound rectangle 120. For example, control circuitry may copy the size and shape of compound rectangle 120 and generate the second captions 116 to fit the first and second rows of characters 118a, 118b in a copied compound rectangle 124.

At 538, control circuitry, e.g., control circuitry of user device 102, displays the second captions 116 on the media content, after which process 500 terminates, or, optionally, continues by returning to 526 following a request to display second captions 116 in a different format or language, for example.

The actions or descriptions of FIG. 5 may be done in any suitable alternative orders or in parallel to further the purposes of this disclosure, and may be combined, where technically appropriate, with the actions or descriptions of any other of the FIGS. disclosed herein.

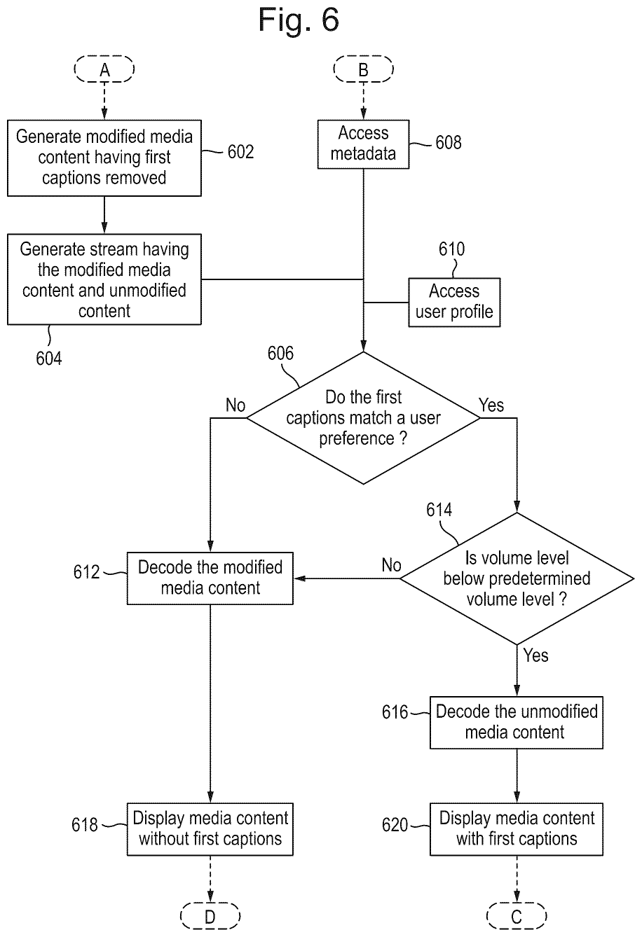

FIG. 6 shows a flowchart representing an illustrative process 600 for displaying media content with or without first captions. While the example shown in FIG. 6 refers to the use of system 100, as shown in FIG. 1, it will be appreciated that the illustrative process 600 shown in FIG. 6 may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of user device 102 and control circuitry of server 104, working either alone or in some combination. As stated above in the description of FIG. 5, process 600 may link, e.g., optionally link or selectively link based on one or more system settings and/or user preferences, to process 500, e.g., via one or more of arrows A, B, C or D.

At 602, control circuitry, e.g., control circuitry of server 104, generates modified media content having the first captions 114 removed, or otherwise rendered not visible. For example, control circuitry may use an inpainting algorithm, such as a texture synthesis based image inpainting algorithm, an isophote driven inpainting algorithm, etc., to remove the first captions from one or more frames of the media content. In some examples, an inpainting algorithm is used in combination with text region detection and/or text recognition techniques in order to efficiently implement the inpainting algorithm. A version of the media content having one or more portions of the first captions removed (e.g., by virtue of inpainting) may be stored as a separate version of the media content. Such a version is referred to herein as a modified version of the media content, since it is different from the version originally received, e.g., at 502.

At 604, control circuitry, e.g., control circuitry of server 104, generates a stream having the modified media content and unmodified content. For example, control circuitry may cause a version of the modified media content and a version of the unmodified content to be encoded for transmission as streamed content. In some examples, a stream may comprise multiple versions of each of the modified media content and unmodified content, e.g., each encoded at different bitrates, to allow for adaptive bit rate (ABR) streaming of the modified media content and unmodified content.

At 606, control circuitry, e.g., control circuitry of user device 102 and/or server 104, determines whether the first captions 114 (of the media content received at 502, for example) match a user preference (and/or one or more system settings), e.g., in a manner similar to the described at 520. For example, control circuitry may access, at 608, the generated metadata and access a user profile (and/or one or more system settings) at 610 to determine whether the first captions match a user preference and/or a system setting. When the captions do not match a user preference and/or a system setting, process 600 moves to 612. When the captions match a user preference and/or a system setting, process 600 moves to 614. For example, control circuitry may determine whether one or more parameters of the first captions 114 match a user preference and/or a system setting indicating a preference for, or how, captions are to be displayed on the media content. Such a preference or setting may relate to a language for displaying captions on the media content. For example, should a user preference and/or system setting indicate that captions should be displayed in Chinese, and the language of the first captions 114 is English, process 600 moves to 612, e.g., since a user has no desire to see the first captions 114. Should a user preference and/or system setting indicate that captions should be displayed in English, and the language of the first captions 114 is English, process 600 moves to 614.

At 612, control circuitry, e.g., control circuitry of user device 102, decodes the modified media content, e.g., in response to a negative output at 606. For example, control circuitry may decode, at an appropriate bitrate, an encoded version of the media content having the first captions 114 removed.

At 614, control circuitry, e.g., control circuitry of user device 102, determines whether a requested or set volume level of the user device 102 is below a predetermined volume level. For example, control circuitry may access a volume setting of user device 102 to determine a current volume level. A requested volume level may be determined by receiving an input, e.g., from a controller of the user device 102, to change the current volume level to a new level, e.g., the requested level. In the example shown in FIG. 6, the modified version of the media content is decoded (at 612) and displayed (at 618) when the volume level is at or above a predetermined volume level, e.g., volume threshold (e.g., 10%, 20%, 50%, or any other desired percent of a max volume). In some examples, 618 may move to 526 of process 500 (as indicated by arrow D). When the volume level is below the predetermined volume level, process 600 moves to 616.

At 616, control circuitry, e.g., control circuitry of user device 102, decodes the unmodified media content, e.g., in response to a positive output at each of 606 and 614. For example, control circuitry may decode, at an appropriate bitrate, an encoded version of the media content having the first captions 114. For example, control circuitry may be configured to display, e.g., by default, at 620, the media content having the first captions 114 when the requested volume level is below a predetermined volume level, e.g., volume threshold (e.g., 10%, 20%, 50%, or any other desired percent of a max volume). In some examples, 620 may move to 516 of process 500 (as indicated by arrow C).

The actions or descriptions of FIG. 6 may be done in any suitable alternative orders or in parallel to further the purposes of this disclosure, and may be combined, where technically appropriate, with the actions or descriptions of any other of the FIGS. disclosed herein.

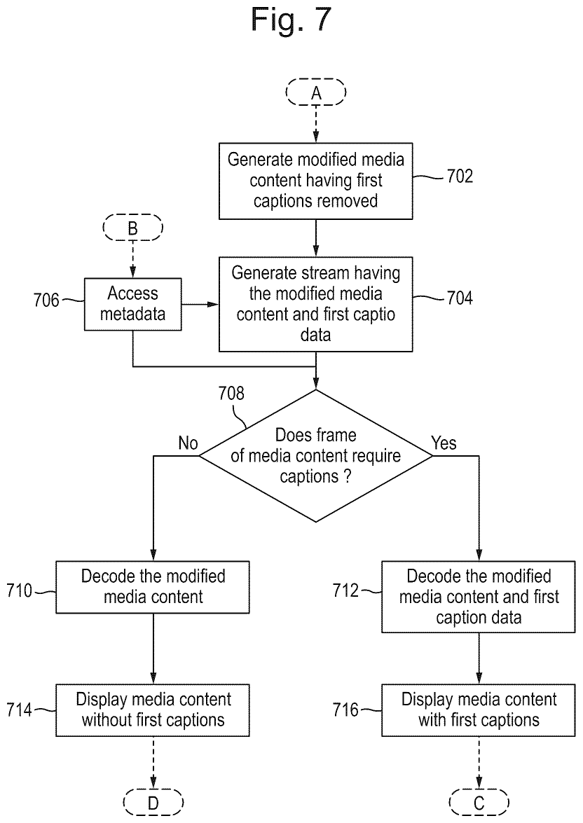

FIG. 7 shows a flowchart representing an illustrative process 700 for displaying media content with or without first captions. While the example shown in FIG. 7 refers to the use of system 100, as shown in FIG. 1, it will be appreciated that the illustrative process 700 shown in FIG. 7 may be implemented, in whole or in part, on system 100, system 200, and/or any other appropriately configured system architecture. For the avoidance of doubt, the term “control circuitry” used in the below description applies broadly to the control circuitry outlined above with reference to FIG. 2. For example, control circuitry may comprise control circuitry of user device 102 and control circuitry of server 104, working either alone or in some combination. As stated above in the description of FIG. 5, process 600 may link, e.g., optionally link or selectively link based on one or more system settings and/or user preferences, to process 500, e.g., via one or more of arrows A, B, C or D.

At 702, control circuitry, e.g., control circuitry of server 104, generates modified media content having the first captions 114 removed, or otherwise rendered not visible, e.g., in a manner similar to that described at 602.

At 704, control circuitry, e.g., control circuitry of server 104, generates a stream having the modified media content, e.g., in a manner similar to that described at 604. In addition, control circuitry generates first caption data for inclusion in the generated stream. For example, control circuitry may access, at 706, the metadata relating to the first captions 114 (e.g., that is generated at 512) and generate instructions for how to generate the first captions 114 for insertion into the modified media content. In other words, control circuitry may generate instructions, accessible by user device 102, that provide the required data for user device 102 to replicate, on the modified version, the display of the first captions 114 as included on the originally received media content.

At 708, control circuitry, e.g., control circuitry of user device 102 and/or server 104, determines whether a frame of the media content requires captions. For example, control circuitry may access metadata at 706 (e.g., that is generated at 512) to determine whether a currently displayed frame and/or one or more upcoming frames, e.g., one or more frames stored in a buffer, require captions, e.g., based on the metadata. Should the one or more frames of the media content not require captions, process 700 moves to 710. Should the one or more frames of the media content require captions, process 700 moves to 712.

At 710, control circuitry, e.g., control circuitry of user device 102, decodes the modified media content and displays, e.g., at user device 102, the modified version at 714. In some examples, 714 of process 700 moves to 526 of process 500 (as indicated by arrow D).

At 712, control circuitry, e.g., control circuitry of user device 102, decodes the modified media content and uses the first caption data to display, e.g., at user device 102 at 714, the modified version having the first captions 114 overlaid onto one or more frames of the modified version of the media content. In this manner, the originally received media content is replicated, and switching between a version of the media content having captions and a version not having captions requires less bandwidth, since the stream need not carry two versions of the media content (e.g., a version having captions and a version not having captions). In some examples, 716 of process 700 moves to 516 of process 500 (as indicated by arrow C).

The actions or descriptions of FIG. 7 may be done in any suitable alternative orders or in parallel to further the purposes of this disclosure, and may be combined, where technically appropriate, with the actions or descriptions of any other of the FIGS. disclosed herein.

The processes described above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one example may be applied to any other example herein, and flowcharts or examples relating to one example may be combined with any other example in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
analyzing, using control circuitry, media content to determine one or more parameters associated with the media content;
generating, using control circuitry, metadata storing the one or more parameters;
receiving, using control circuitry, a request to display the media content with second captions; and
generating, using control circuitry, for display on the media content the second captions based on the metadata.

2. The method of claim 1, the method comprising:
determining, based on the metadata, whether the first captions do not meet one or more user preferences; and
generating the second captions in response to the first captions not meeting one or more user preferences.

3. The method of claim 1, the method comprising:
receiving a request to display the second captions in a language;
accessing the metadata in response to the request;
determining, based on the metadata, whether the language of the requested second captions matches a language of the first captions; and
in response to the language of the requested second captions matching the language of the first captions, disregarding the request to display the second captions.

4. The method of claim 1, wherein analyzing the media content comprises at least one of:
analyzing the media content to determine one or more portions of the media content having the first captions;
analyzing the media content to determine a visual parameter of the first captions;
analyzing the media content to determine an audio parameter of the media content; and
accessing metadata of the media content.

5. The method of claim 1, the method comprising:
generating modified media content by removing the first captions;
generating a stream for transmitting the media content, the stream having a version of the modified media content and a version of unmodified media content encoded therein;
determining a user preference;
comparing the user preference with the metadata; and
decoding, for display, the unmodified media content when the user preference matches a parameter stored in the metadata; or
decoding, for display, the modified media content when the user preference does not match a parameter stored in the metadata.

6. The method of claim 5, the method comprising:
determining a requested volume level of the media content; and
displaying, by default, the unmodified version of the media content when the requested volume level is below a predetermined volume level.

7. The method of claim 1, the method comprising:
processing the media content to generate modified media content not having the first captions and a file containing first caption data;
generating a stream for transmitting the media content, the stream having a version the modified media content and the first caption data encoded therein;
determining a user preference;
comparing the user preference with the metadata; and
decoding, for display, the modified media content when the user preference does not match a parameter stored in the metadata; or
decoding, for display, the modified media content and the first caption data when the user preference matches a parameter stored in the metadata.

8. The method of claim 1, the method comprising:
determining whether a quality of the first captions is less than a quality value; and
receiving a request to display the media content with second captions in response to determining that the quality of the first captions is less than the quality value.

9. The method of claim 1, the method comprising at least one of:
displaying the second captions at a position on the media content to not obscure the first captions;
displaying the second captions at a position on the media content to obscure the first captions.

10. The method of claim 1, wherein generating the second captions comprises inpainting an area covered by the first captions.

11. A system comprising control circuitry configured to:
analyze media content to determine one or more parameters associated with the media content;
generate metadata storing the one or more parameters;
receive a request to display the media content with second captions; and
generate for display on the media content the second captions based on the metadata.

12. The system of claim 11, wherein control circuitry is configured to:
determine, based on the metadata, whether the first captions do not meet one or more user preferences; and
generate the second captions in response to the first captions not meeting one or more user preferences.

13. The system of claim 11, wherein control circuitry is configured to:
receive a request to display the second captions in a language;
access the metadata in response to the request;
determine, based on the metadata, whether the language of the requested second captions matches a language of the first captions; and
in response to the language of the requested second captions matching the language of the first captions, disregard the request to display the second captions.

14. The system of claim 11, wherein, when analyzing the media content, control circuitry is configured to at least one of:
analyze the media content to determine one or more portions of the media content having the first captions;
analyze the media content to determine a visual parameter of the first captions;
analyze the media content to determine an audio parameter of the media content; and
access metadata of the media content.

15. The system of claim 11, wherein control circuitry is configured to:
generate modified media content by removing the first captions;
generate a stream for transmitting the media content, the stream having a version of the modified media content and a version of unmodified media content encoded therein;
determine a user preference;
compare the user preference with the metadata; and
decode, for display, the unmodified media content when the user preference matches a parameter stored in the metadata; or
decode, for display, the modified media content when the user preference does not match a parameter stored in the metadata.

16. The system of claim 15, wherein control circuitry is configured to:
determine a requested volume level of the media content; and
display, by default, the unmodified version of the media content when the requested volume level is below a predetermined volume level.

17. The system of claim 11, wherein control circuitry is configured to:
process the media content to generate modified media content not having the first captions and a file containing first caption data;
generate a stream for transmitting the media content, the stream having a version the modified media content and the first caption data encoded therein;
determine a user preference;
compare the user preference with the metadata; and
decode, for display, the modified media content when the user preference does not match a parameter stored in the metadata; or
decode, for display, the modified media content and the first caption data when the user preference matches a parameter stored in the metadata.

18. The system of claim 11, wherein control circuitry is configured to:
determine whether a quality of the first captions is less than a quality value; and
receive a request to display the media content with second captions in response to determining that the quality of the first captions is less than the quality value.

19. The system of claim 11, wherein control circuitry is configured to at least one of:
display the second captions at a position on the media content to not obscure the first captions;
display the second captions at a position on the media content to obscure the first captions.

20. The system of claim 11, wherein control circuitry is configured to generate the second captions by inpainting an area covered by the first captions.

21-50. (canceled)
